(19) United States
(12) Patent Application Publication
(10) Pub. No.: US 2009/0184831 A1
(43) Pub. Date: Jul. 23, 2009

(54) Controlling device of a multifunctional lamp

(76) Inventor: Tsung-Jung Huang, Taipei City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 12/385,097

(22) Filed: Mar. 31, 2009

Related U.S. Application Data
(63) Continuation-in-part of application No. 11/523,517, filed on Sep. 20, 2006, now abandoned.

(51) Int. Cl. G08B 17/10; H05B 37/00

(52) U.S. Cl. 340/628; 315/86

(57) ABSTRACT

A controlling device of a multifunctional lamp, which includes: a spare power supply circuit; a controller connectable to an external power supply circuit and the spare power supply circuit; and a voltage modulation module connected between the controller and a powered end equipment. According to the control of a user and according to whether the external power supply circuit normally supplies power, the controller can automatically judge and choose the power source. The controller includes a central processing unit and a rectifying module connected to the external power supply circuit for respectively sending rectified power to the spare power supply circuit and the voltage modulation module. The central processing unit serves to control the voltage modulation module to or not to supply power for the powered end equipment. The controller is also electrically connectable to an emergency detection system to achieve an emergency detection function.

### CROSS-REFERENCE TO RELATED APPLICATION

This application is a continuation-in-part application of U.S. patent application Ser. No. 11/523,517.

### BACKGROUND OF THE INVENTION

The present invention is related to a controlling device of a multifunctional lamp, which enables the multifunctional lamp to uninterruptedly provide illuminating function no matter whether the external power is normally supplied or shut off. The controlling device of the multifunctional lamp also provides emergency detection function. In addition, the controlling device can be more easily assembled than the conventional controlling device.

An emergency illumination device serves to uninterruptedly continuously provide illuminating effect in the case of shutoff of normal power (civil power). The emergency illumination device provides basic illumination for a house, a working site or an escape passage, whereby people can temporarily emergently handle the situation and be guided to escape from the escape passage. The conventional escape guiding equipment includes exit indicator lamp positioned above the safety door and the direction indicator lamp arranged in the corner. With the emergency illumination device, in the case that the normal power is shut off, people can still tell the escape direction and the position of the safety door so as to ensure safety.

Most of the typical emergency lights are wall emergency lights. In general, the emergency lights are mounted on the walls of the hallways, the staircases, the escape passages, etc. of various sites. Generally, an emergency light is equipped with an AC/DC automatic switching unit. At normal time, the spare battery is automatically charged by AC power. When saturated, the AC power will automatically stop charging the battery. In the case that the power is shut off, the emergency light is switched to the spare battery for supplying power as emergent illumination.

The emergency light is independent from the original illuminator of a site. A consumer often purchases emergency lights and installs the emergency lights in a building. However, as aforesaid, the emergency lights are mounted on the walls of the hallways, the staircases, the escape passages, etc. In the case that the civil power is shut off, the emergency lights can only project light from the walls toward the ground. The illuminated area is quite limited.

An indoor illuminator in a house or a working site, such as a fluorescent lamp, is turned on or off by means of a switch. The common fluorescent lamp is powered on by civil power supply. In contrast to the common fluorescent lamp, the conventional emergency light is extinguished at normal time and provides illuminating effect only when the power is shut off. It is tried by the applicant to provide an emergency lamp, which can still provide illuminating function in the case that the civil power is shut off. Accordingly, the indoor light not only serves to provide illuminating effect at normal time, but also serves as an emergency light for providing illuminating function in an emergency.

FIG. 1 shows a conventional illuminating device equipped with an uninterruptible power system. In order to detect the supply state of the civil power and provide reserved power for the uninterruptible power system, another power line B is additionally connected between the original power line A and grounding line C and connected to the controlling circuit of the uninterruptible power system. The power line B is for detecting the state of the power supply and charging the uninterruptible power system. Such arrangement can achieve the uninterruptible illuminating effect. However, it is quite troublesome to install such equipment and the installation necessitates specialists. It is therefore tried by the applicant to provide a simplified layout of the respective components. For example, a controller can be added to detect the state of supply of the civil power. In addition, in precondition of no additional working procedure, the layout of the uninterruptible power system is improved to simplify the arrangement of the device.

Moreover, the present invention is applicable to other emergency equipment. In case that the normal power is shut off, the emergency equipment can be still powered on to keep the detection or alarm function.

### SUMMARY OF THE INVENTION

It is therefore a primary object of the present invention to provide a controlling device of a multifunctional lamp, which uninterruptedly and more stably provides illuminating effect no matter whether the external power is normally supplied or shut off.

It is a further object of the present invention to provide the above controlling device of the multifunctional lamp, which includes a controller for detecting the state of the connection between the external power supplying circuit and the uninterruptible equipment, (especially the switching state of the switch). The controller serves to control turning on/extinguishing of the lamp. Also, the arrangement of the controlling device is simplified.

It is a further object of the present invention to provide the above controlling device of the multifunctional lamp, which can be electrically connected to a detection system to also have a heat/smoke detection function.

According to the above objects, the controlling device of the multifunction lamp of the present invention includes a spare power supply circuit for providing spare power, a controller connectable to an external power supply circuit and the spare power supply circuit, and a voltage modulation module connected between the controller and a powered end equipment. The controller is controllable by a user to choose the power source. Alternatively, the controller itself can judge and choose the power source according to whether the external power supply circuit normally supplies power. The controller includes a rectifying module and a central processing unit. The rectifying module is connected to the external power supply circuit to respectively send the rectified power to the spare power supply circuit and the voltage modulation module. According to the power state of the external power supply circuit, the central processing unit controls the voltage modulation module to or not to supply power for the powered end equipment. In addition, the controller can be electrically connected to a detection system to also provide emergency detection function.

The present invention can be best understood through the following description and accompanying drawings wherein:

### BRIEF DESCRIPTION OF THE DRAWINGS

FIG. 1 is a schematic diagram of a conventional lamp having emergency illumination function, showing the layout thereof;

FIG. 2 is a block diagram of a preferred embodiment of the present invention;

FIG. 3 is a block diagram of the rectifying module of the present invention according to FIG. 2, showing the components of the rectifying module;

FIG. 4 is a block diagram of the voltage modulation module of the present invention according to FIG. 2, showing the components of the voltage modulation module;

FIG. 5 is a block diagram of the detection circuit of the rectifying module of the present invention, showing the components of the detection circuit;

FIG. 6 is a schematic diagram of the preferred embodiment of the present invention, showing the layout thereof;

FIG. 7 is a perspective view of the preferred embodiment of the present invention;

FIG. 8 is a perspective view of another embodiment of the present invention;

FIG. 9 is a block diagram of another type of voltage modulation module of the present invention, showing the components of the voltage modulating module; and

FIG. 10 is a block diagram of still another embodiment of the present invention, which also includes an emergency detection system.

### DETAILED DESCRIPTION OF THE PREFERRED EMBODIMENTS

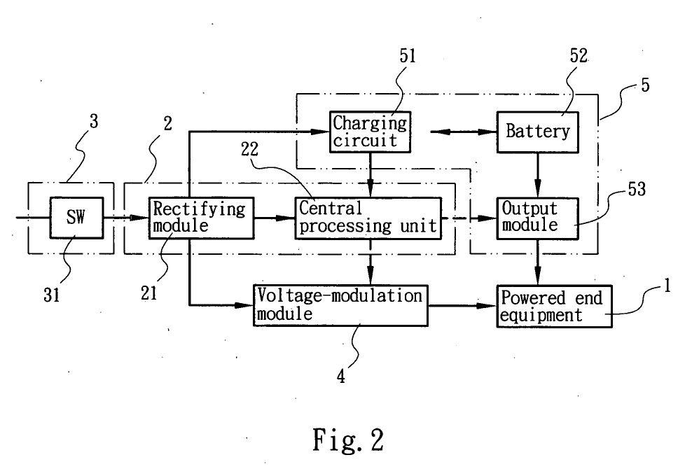

Please refer to FIG. 2. The controlling device of the multifunctional lamp of the present invention includes a spare power supply circuit 5 for providing spare power, a controller 2 connectable to an external power supply circuit 3 and the spare power supply circuit 5 and a voltage modulation module 4 connected between the controller 2 and a powered end equipment 1. In this embodiment, the powered end equipment 1 is an electric light, a fluorescent lamp, a light-emitting diode or any other electric light-emitting unit. According to the control of a user and according to whether the external power supply circuit 3 normally supplies power, the controller 2 can automatically judge and choose the power source. The controller 2 includes a rectifying module 21 and a central processing unit 22. The rectifying module 21 is connected to the external power supply circuit 3 to respectively send the rectified power to the spare power supply circuit 5 and the voltage modulation module 4. According to the feedback power state signal of the rectifying module 21, the central processing unit 22 controls the voltage modulation module 4 to or not to supply power for the powered end equipment 1. The central processing unit 22 is connected to the spare power supply circuit 5. In the case that the external power supply circuit 3 fails to supply power, the central processing unit 22 can be powered by the spare power supply circuit 5.

In this embodiment, the external power supply circuit 3 can be a civil power, a power supply circuit of a generator or an externally connected power supply. The spare power supply circuit 5 includes a charging circuit 51, a battery 52 connected with the charging circuit 51 and an output module 53 connected with the battery 52. The rectifying module 21 sends the power to the charging circuit 51. According to the state of power reservation of the battery 52, the charging circuit 51 charges the battery 52. The output module 53 is controlled by the central processing unit 22, whereby when the external power supply circuit 3 stops supplying power, the output module 53 emergently outputs the power of the battery 52 to the powered end equipment 1. Also, the charging circuit 51 is connected to the central processing unit 22 for conducting the power of the battery 52 to provide necessary power for the controller 2. Accordingly, at normal time and during the shutoff period, the controller 2 can keep normally working. In another preferred embodiment, the central processing unit 22 is connected to the spare power supply circuit 5 (directly connected to the charging circuit 52) to detect the state of power reservation of the battery 52. Accordingly, the controller 2 can judge whether the battery 52 should be charged or not.

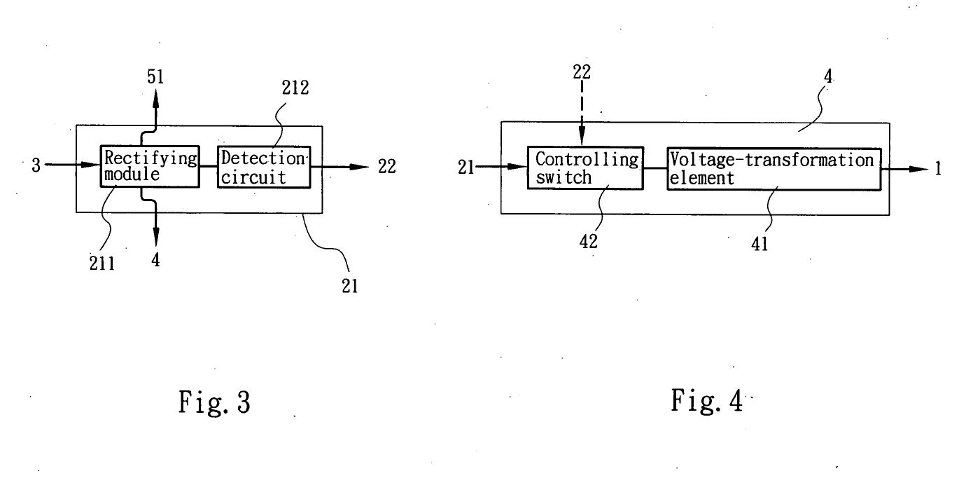

Referring to FIG. 3, in this embodiment, the rectifying module 21 includes a rectifying circuit 211 and a detection circuit 212. The rectifying circuit 211 is connected to the external power supply circuit 3. In practice, the external power supply module 3 has a switch 31. One end of the switch 31 is connected to the civil power, while the other end of the switch 31 is connected to the rectifying circuit 211. In general, the switch 31 is a two-stage switch. The detection circuit 212 serves to detect whether the rectifying circuit 211 is supplied with power from the external power supply module 3 and serves to send a signal of detection result to the central processing unit 22 for judgment. In addition, via the detection circuit 212, the central processing unit 22 obtains necessary power from the rectifying circuit 211.

Referring to FIG. 4, according to a preferred embodiment, the voltage modulation module 4 includes a controlling switch 42 and a voltage transformation element 41. The controlling switch 42 obtains power from the rectifying module 21. In addition, the central processing unit 22 serves to transmit a controlling signal to control the closing/opening of the controlling switch 42. In this embodiment, the powered end equipment 1 can be at least one fluorescent tube. The voltage transformation element 41 is a stabilizer adapted to the fluorescent tube.

In operation, the greatest difference between the present invention and the conventional lamp equipped with an uninterruptible power system is that it is unnecessary to additionally connect another power line B. In contrast, the original power line A is directly used. In this embodiment, the detection circuit 212 of the rectifying module 21 detects the state of the switch 31 of the external power supply circuit 3. By means of the control of the central processing unit 22, the original power circuit is directly used to supply power for the spare power supply circuit 5 without additional working. Accordingly, it is unnecessary to additionally lay any other power circuit to supply power for the spare power supply circuit 5. To speak in more detail, the multifunctional lamp of the present invention obtains power in such a manner that according to the state of the switch 31 or the power input mode of the switch 31 operated by a user, the central processing unit 22 judges whether a user turns on the lamp, turns off the lamp or the external power supply circuit 3 stops supplying power.

According to the aforesaid, in the case that the power supply for the central processing unit 22 is chosen between the states of the switch 31, a small load (such as a resistor or a neon lamp) must be parallelly connected between two contacts of two ends of the switch 31, (that is, two contacts for forming closing/opening). This is for forming a weak current, which will still enter the controller 2 when the switch 31 is opened. Referring to FIG. 3, no matter whether the switch 31 is closed or opened, a current is generated. Under such circumstance, the rectifying circuit 21 will always be provided with power by the external power supply module 3. They are only different in the magnitude of current. However, no matter how great the magnitude of the current is, the current entering the rectifying module 21 is AC power, that is, the current has a constant frequency (of 50 Hz or 60 Hz). In contrast, there is no current entering the rectifying module 21, (that is, the frequency is 0 Hz). The detection circuit 212 transmits detection signals of these two different power frequency states to the central processing unit 22 for judging whether the power is shut off and whether it is necessary to turn on the spare power.

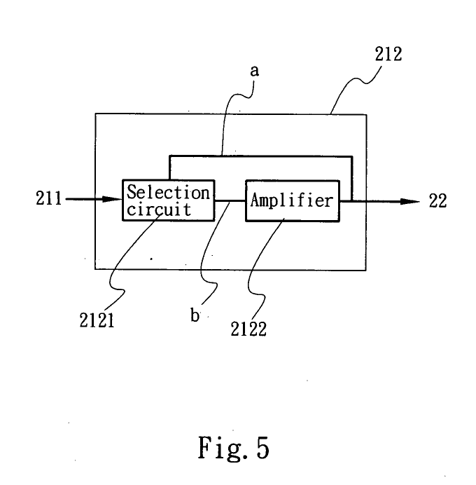

Referring to FIG. 5, in the aforesaid detection type of multifunctional lamp of the present invention, the detection circuit 212 includes a selection circuit 2121 and an amplifier 2122 successively electrically connected to the selection circuit 2121. When a user switches the switch 31 to a closed state, the rectifying circuit 211 transfers the rectified power to the charging circuit 51. At the same time, the selection circuit 2121 detects a high-level state with frequency change. (Depending on the design of the circuit, the selection circuit 2121 may alternatively detect a low-level state with frequency change.) The selection circuit 2121 directly transmits the detection state to the central processing unit 22 via a route a. The central processing unit 22 will define this state as turning-on of light to restrain the voltage modulation module 4 from being turned on. Reversely, when the switch 31 is switched to an open state, the selection circuit 2121 will detect a low-level state with frequency change. (Depending on the design of the circuit, the selection circuit 2121 may alternatively detect a high-level with frequency change.) The selection circuit 2121 directly transmits the detection state to the amplifier 2122 via a route b. After amplified to a certain extent, the detection signal is transmitted to the central processing unit 22. The central processing unit 22 will define this state as turning-off of light to open the voltage modulation module 4. In case of power cut, the detection circuit 212 will not detect any supplied power and thus will not detect any power frequency change. (Depending on the design of the circuit, the detection circuit 212 alternatively will not detect any level signal with special frequency change.) The central processing unit 22 will define the detection signal without frequency change as power cut state to turn on the spare power supply circuit 5.

In another power supply selection of the central processing unit 22, the selection is made on the basis of the mode in which a user operates the switch 31, wherein the switch 31 is kept in a closed state (to form the additional power line B as in the conventional device). When a user turns on the lamp, it is necessary for the user to “open and close” the switch 31 in a preset time, (for example, in one second). (That is, the user needs to switch off the switch 31 and then switch on the switch 31 in the preset time.) At this time, the detection circuit 212 of the rectifying module 21 detects this power change (from the original high level of closed state into a low level and then from the low level into the high level in the preset time). However, due to differences between the designs of the circuits, such procedure alternatively can be a two-stage change of level. The central processing unit 22 will close or open the voltage modulation module 4 on the basis of the change of level. In the case that the lamp originally is not turned on, the central processing unit 22 will restrain the controlling switch 42 from being switched on and the powered end equipment 1 is lighted up via the voltage transformation element 41. Identically, when the user desires to turn off the lamp, the switch 31 is repeatedly opened and closed to turn off the lamp.

In the case that the external power supply module 3 stops supplying power, the switch 31 is still switched on. However, without the external power, the detection circuit 212 will detect a low level for a longer time (obviously longer than the aforesaid preset time). The central processing unit 22 will define such longer low-level state as a power cut state. (Due to the differences between the designs of the circuits, the detection circuit 212 will alternatively detect a high level for a longer time.) Under such circumstance, the central processing unit 22 will activate the spare power supply circuit 5 to emergently supply power. Also, the switch 31 is switched off and kept in an open state. This simulates the power cut state of the external power supply module 3 and also tests whether the spare power supply circuit 5 can normally work. Accordingly, the uninterrupted power system can be maintained. It should be noted that in comparison with the present invention, the conventional emergency illumination equipment is hung on a wall in a higher position. It is uneasy to maintain or test the conventional emergency illumination equipment. In contrast, a user only needs to control the state of the switch 31 to achieve the same object.

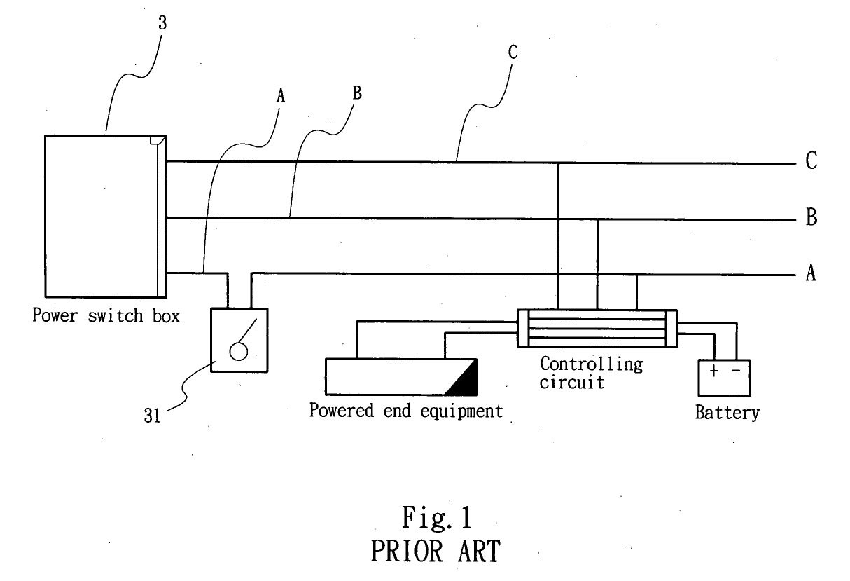

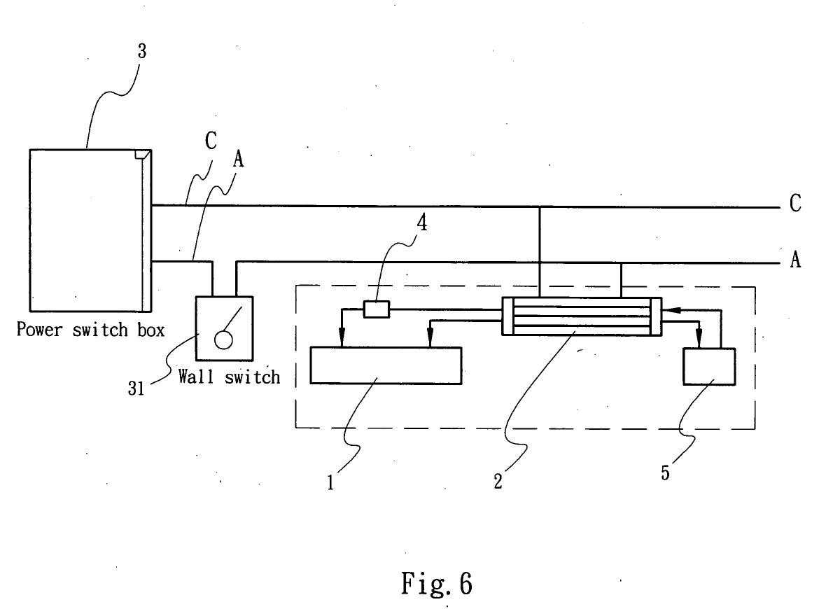

In both the above controlling modes, there is no additional power line B and the layout is simplified into the arrangement as shown in FIG. 6. The switch 31 is directly connected to the lamp of the present invention. It should be noted that the structure of FIG. 6 is totally identical to the existent power layout. Therefore, when installing the multifunctional lamp of the present invention, it is unnecessary to troublesomely lay out any additional power line B as in the conventional uninterrupted power system. Furthermore, A preferred application pattern of connection between the present invention and the powered end equipment 1 is shown as the area enclosed by the phantom lines of FIG. 6. In comparison with the lamp with uninterrupted power system of FIG. 1, the present invention enables the lamp to have illuminating effect in normal state. In addition, in the case that the external power supply circuit 3 stops supplying power, the lamp can be still continuously lighted up for a certain time.

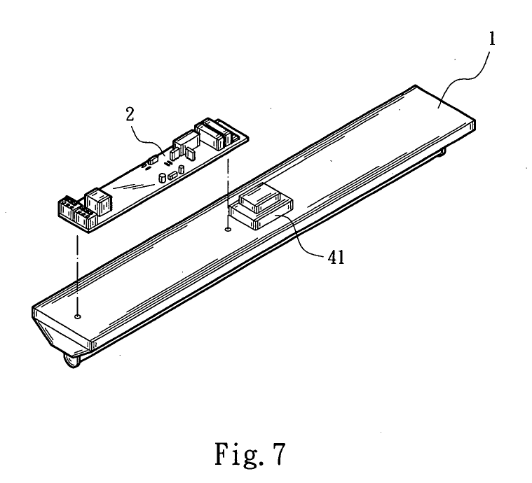

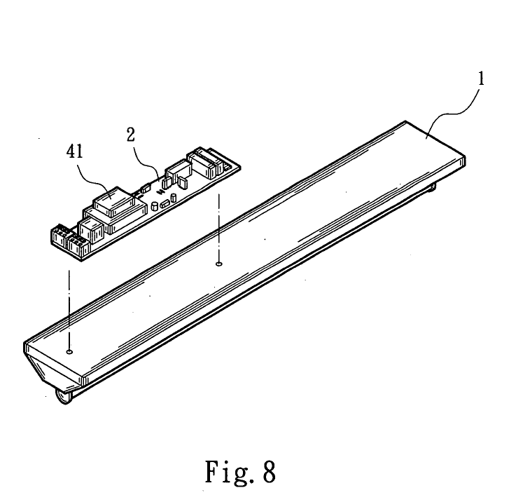

In the multifunctional lamp of the present invention, the controller 2 and the spare power supply circuit 5 can be integrated into a controlling device. The controlling device can be used in cooperation with a powered end equipment 1 itself equipped with a voltage transformation element 41 (as shown in FIG. 7). Alternatively, the voltage transformation element can be previously disposed in the controller 2 (as shown in FIG. 8) and then integrated with the spare power supply circuit 5 to form a complete device. The complete device is then used in cooperation with the powered end equipment 1 to form a multifunctional lamp.

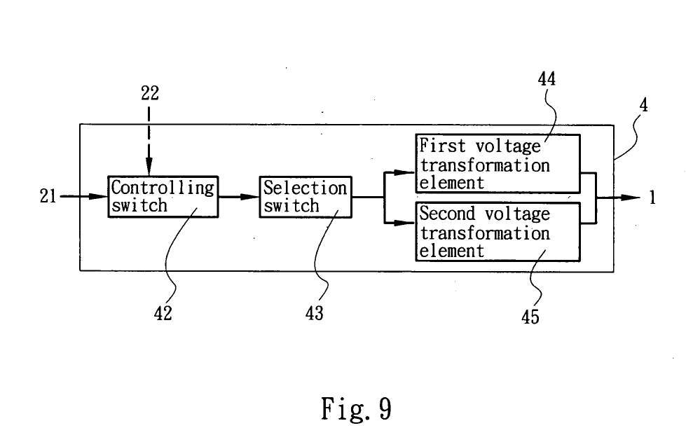

FIG. 9 shows another embodiment of the present invention, in which the voltage modulation module 4 includes a controlling switch 42, a selection switch 43, a first voltage transformation element 44 and a second voltage transformation element 45. The controlling switch 42 is identical to the aforesaid one. The controlling switch 42 is connected to the selection switch 43, which selects one of the two voltage transformation elements to output power to the powered end equipment 1. (The selection switch 43 is connectable to more than two voltage transformation elements.) The first and second voltage transformation elements 44, 45 are laid out as shown in FIGS. 7 and 8 respectively. In short, the second voltage transformation element 45 is arranged on the controller 2 and connected to the powered end equipment 1 with the first voltage transformation element 44. A user can switch the selection switch 43 to choose the first voltage transformation element 44 or the second voltage transformation element 45 for turning on/off the powered end equipment 1.

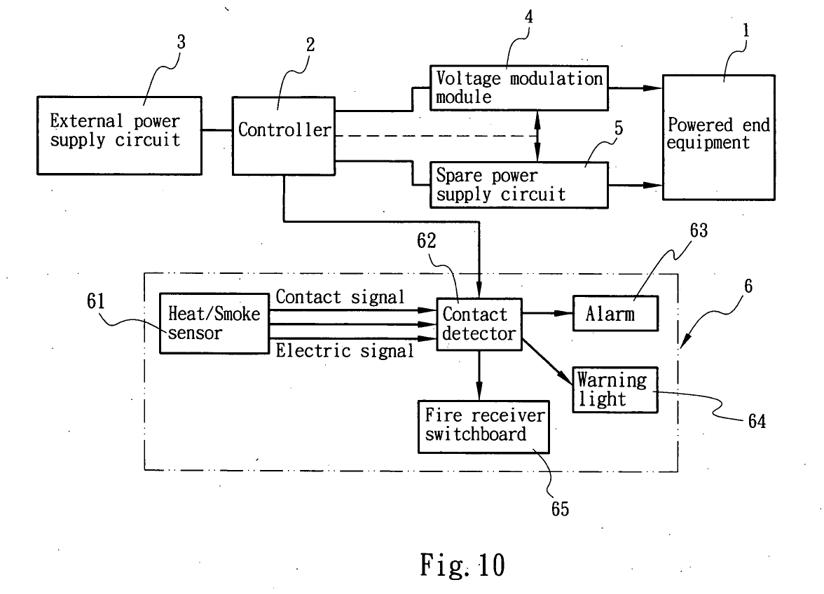

In FIG. 10, an emergency detection system 6 is added to the emergency illuminating system. In short, the emergency illuminating system of the present invention is uninterruptedly powered on so that the emergency detection system 6 can keep operating in any case.

As shown in FIG. 10, the emergency detection system 6 is bridged with the controller 2 of the emergency illuminating system. In this embodiment, a heat/smoke sensor 61 and a contact detector 62 are preset in the detection system 6. The heat/smoke sensor 61 and contact detector 62 are always powered on in any case. Therefore, in case of abnormal condition, an electric signal is transmitted to activate a preset alarm 63, a warning light 64 and a fire receiver switchboard 65. It should be noted that the heat/smoke sensor 61 of the detection system 6 is simply an embodiment of the sensor of the present invention.

Besides, in consideration of saving energy, the powered end equipment 1 can be an LED lamp with lower power consumption. In addition, the voltage transformation element 41 is a voltage transformation unit adapted to the LED lamp. The voltage transformation unit serves to transform the power of the rectifying module 21 into the power suitable for the LED lamp as the powered end equipment 1. Similarly, the output module 53 of the spare power supply circuit 5 is correspondingly designed.

In conclusion, the controlling device of the multifunctional lamp of the present invention can be easily laid out and have better function. The present invention enables the multifunctional lamp to uninterruptedly provide illuminating function in both the cases that the external power is supplied and the civil power is cut off. The controlling device of the multifunctional light can be also connected to an emergency detection system 6 to provide emergency detection function.

The above embodiments are only used to illustrate the present invention, not intended to limit the scope thereof. Many modifications of the above embodiments can be made without departing from the spirit of the present invention.

What is claimed is:

1. A controlling device of a multifunctional lamp, comprising:
a spare power supply circuit for providing spare power;
a controller connectable to an external power supply circuit and the spare power supply circuit; and
a voltage modulation module connected between the controller and a powered end equipment, the controller including a rectifying module and a central processing unit, the rectifying module being connected to the external power supply circuit to respectively send rectified power to the spare power supply circuit and the voltage modulation module, according to power states of the external power supply circuit, the central processing unit controlling the voltage modulation module to or not to supply power for the powered end equipment, the central processing unit also controlling the spare power supply circuit to or not to be activated, the central processing unit being connected to the spare power supply circuit, whereby in the case that the external power supply circuit stops supplying power, the central processing unit can controllably select the spare power supply circuit to supply power to the powered end equipment, whereby according to the control of a user and according to whether the external power supply circuit normally supplies power, the controller can automatically judge and choose the power source.

2. The controlling device of the multifunctional lamp as claimed in claim 1, wherein the spare power supply circuit includes a charging circuit, a battery connected with the charging circuit and an output module connected with the battery, the output module being controlled by the central processing unit to or not to electrically connect with the powered end equipment, the rectifying module serving to transfer power to the charging circuit, whereby according to the states of power reservation of the battery, the charging circuit decides to or not to supply power to the battery, the charging circuit being further connected to the central processing unit.

3. The controlling device of the multifunctional lamp as claimed in claim 1, wherein the spare power supply circuit includes a charging circuit, a battery connected with the charging circuit and an output module connected with the battery, the output module being controlled by the central processing unit to or not to electrically connect with the powered equipment, the rectifying module serving to transfer power to the charging circuit, the central processing unit being connected with the spare power supply circuit for detecting the states of power reservation of the battery so as to control the charging circuit to or not to supply power to the battery, charging circuit being further connected to the central processing unit.

4. The controlling device of the multifunctional lamp as claimed in claim 1, wherein the rectifying module includes a rectifying circuit and a detection circuit, the rectifying circuit being connected to a switch disposed in the external power supply circuit, the detection circuit being connected to the rectifying circuit and the central processing unit.

5. The controlling device of the multifunctional lamp as claimed in claim 2, wherein the rectifying module includes a rectifying circuit and a detection circuit, the rectifying circuit being connected to a switch disposed in the external power supply circuit, the detection circuit being connected to the rectifying circuit and the central processing unit.

6. The controlling device of the multifunctional lamp as claimed in claim 3, wherein the rectifying module includes a rectifying circuit and a detection circuit, the rectifying circuit being connected to a switch disposed in the external power supply circuit, the detection circuit being connected to the rectifying circuit and the central processing unit.

7. The controlling device of the multifunctional lamp as claimed in claim 4, wherein the detection circuit includes a selection circuit externally connected to the central processing unit and an amplifier externally connected to the central processing unit.

8. The controlling device of the multifunctional lamp as claimed in claim 1, wherein according to the feedback of the detection signal change of the rectifying module, the central processing unit decides to close or open the voltage modulation module.

9. The controlling device of the multifunctional lamp as claimed in claim 8, wherein the detection signal is a high-level signal with frequency change.

10. The controlling device of the multifunctional lamp as claimed in claim 8, wherein the detection signal is a low-level signal with frequency change.

11. The controlling device of the multifunctional lamp as claimed in claim 8, wherein during a preset short time period, the detection signal is two-stage changed from an initial level between a high-level state and a low-level state.

12. The controlling device of the multifunctional lamp as claimed in claim 1, wherein according to the feedback of the detection signal change of the rectifying module, the central processing unit decides to or not to activate the spare power supply circuit to emergently supply power.

13. The controlling device of the multifunctional lamp as claimed in claim 12, wherein the detection signal is a level signal without frequency change.

14. The controlling device of the multifunctional lamp as claimed in claim 12, wherein the detection signal is a level signal with special frequency change.

15. The controlling device of the multifunctional lamp as claimed in claim 12, wherein the state of the detection signal is a low-level state for a longer time.

16. The controlling device of the multifunctional lamp as claimed in claim 12, wherein the state of the detection signal is a high-level state for a longer time.

17. The controlling device of the multifunctional lamp as claimed in claim 1, wherein the voltage modulation module includes a controlling switch connected to the rectifying module and a voltage transformation element connected to the controlling switch and externally connected to the powered end equipment.

18. The controlling device of the multifunctional lamp as claimed in claim 4, wherein the voltage modulation module includes a controlling switch connected to the rectifying module and a voltage transformation element connected to the controlling switch and externally connected to the powered end equipment.

19. The controlling device of the multifunctional lamp as claimed in claim 7, wherein the voltage modulation module includes a controlling switch connected to the rectifying module and a voltage transformation element connected to the controlling switch and externally connected to the powered end equipment.

20. The controlling device of the multifunctional lamp as claimed in claim 1, wherein the voltage modulation module includes a controlling switch connected to the rectifying module and a selection switch, the selection switch being connected to at least two voltage transformation elements, whereby the selection switch can control one of the voltage transformation elements to electrically connect with the controlling switch.

21. The controlling device of the multifunctional lamp as claimed in claim 4, wherein the voltage modulation module includes a controlling switch connected to the rectifying module and a selection switch, the selection switch being connected to at least two voltage transformation elements, whereby the selection switch can control one of the voltage transformation elements to electrically connect with the controlling switch.

22. The controlling device of the multifunctional lamp as claimed in claim 7, wherein the voltage modulation module includes a controlling switch connected to the rectifying module and a selection switch, the selection switch being connected to at least two voltage transformation elements, whereby the selection switch can control one of the voltage transformation elements to electrically connect with the controlling switch.

23. The controlling device of the multifunctional lamp as claimed in claim 1, further comprising a detection system including:
a detection sensor for detecting whether environmental state is abnormal and emitting an electric signal in case the environmental state is abnormal; and
a contact detector supplied with power under control of the controller, whereby when the contact detector receives the electric signal, the contact detector automatically outputs an emergency processing signal.

24. The controlling device of the multifunctional lamp as claimed in claim 2, further comprising a detection system including:
a detection sensor for detecting whether environmental state is abnormal and emitting an electric signal in case the environmental state is abnormal; and
a contact detector supplied with power under control of the controller, whereby when the contact detector receives the electric signal, the contact detector automatically outputs an emergency processing signal.

25. The controlling device of the multifunctional lamp as claimed in claim 3, further comprising a detection system including:
a detection sensor for detecting whether environmental state is abnormal and emitting an electric signal in case the environmental state is abnormal; and
a contact detector supplied with power under control of the controller, whereby when the contact detector receives the electric signal, the contact detector automatically outputs an emergency processing signal.

26. The controlling device of the multifunctional lamp as claimed in claim 4, further comprising a detection system including:
a detection sensor for detecting whether environmental state is abnormal and emitting an electric signal in case the environmental state is abnormal; and
a contact detector supplied with power under control of the controller, whereby when the contact detector receives the electric signal, the contact detector automatically outputs an emergency processing signal.

27. The controlling device of the multifunctional lamp as claimed in claim 23, wherein the detection system further includes sensor is a heat sensor or a smoke sensor.

28. The controlling device of the multifunctional lamp as claimed in claim 26, wherein the detection sensor is a heat sensor or a smoke sensor.

29. The controlling device of the multifunctional lamp as claimed in claim 23, wherein the detection system further includes an alarm, when the contact detector outputs the emergency processing signal, the alarm emitting an alarm sound.

30. The controlling device of the multifunctional lamp as claimed in claim 6, wherein the detection system further includes an alarm, when the contact detector outputs the emergency processing signal, the alarm emitting an alarm sound.

31. The controlling device of the multifunctional lamp as claimed in claim 23, wherein the detection system further includes a fire receiver switchboard, when the contact detector outputs the emergency processing signal, the fire receiver switchboard performing a preset emergency program.

32. The controlling device of the multifunctional lamp as claimed in claim 26, wherein the detection system further includes a fire receiver switchboard, when the contact detector outputs the emergency processing signal, the fire receiver switchboard performing a preset emergency program.

33. The controlling device of the multifunctional lamp as claimed in claim 17, wherein the voltage transformation element is a stabilizer.

34. The controlling device of the multifunctional lamp as claimed in claim 18, wherein the voltage transformation element is a stabilizer.

35. The controlling device of the multifunctional lamp as claimed in claim 19, wherein the voltage transformation element is a stabilizer.

36. The controlling device of the multifunctional lamp as claimed in claim 17, wherein the voltage transformation element is a voltage transformation unit.

37. The controlling device of the multifunctional lamp as claimed in claim 18, wherein the voltage transformation element is a voltage transformation unit.

38. The controlling device of the multifunctional lamp as claimed in claim 19, wherein the voltage transformation element is a voltage transformation unit.

39. The controlling device of the multifunctional lamp as claimed in claim 1, wherein the powered end equipment is at least one fluorescent tube.

40. The controlling device of the multifunctional lamp as claimed in claim 4, wherein the powered end equipment is at least one fluorescent tube.

41. The controlling device of the multifunctional lamp as claimed in claim 1, wherein the powered end equipment is a lamp composed of LEDs.

42. The controlling device of the multifunctional lamp as claimed in claim 4, wherein the powered end equipment is a lamp composed of LEDs.

43. The controlling device of the multifunctional lamp as claimed in claim 7, wherein the powered end equipment is a lamp composed of LEDs.
